(19) United States
(12) Patent Application Publication
(10) Pub. No.: US 2008/0136364 A1
(43) Pub. Date: Jun. 12, 2008

(54) BATTERY CHARGING USING THERMOELECTRIC DEVICES

(76) Inventor: Russell Calvarese, Stony Brook, NY (US)

Correspondence Address: THORNE & HALAJIAN;APPLIED TECHNOLOGY CENTER, 111 WEST MAIN STREET, BAY SHORE, NY, 11706, US

(21) Appl. No.: 11/608,535

(22) Filed: Dec. 8, 2006

(51) Int. Cl. H02J 7/02; H01M 10/44

(52) U.S. Cl. 320/101

(57) ABSTRACT

A charging system includes a first thermoelectric module (TEM) connectable to a power source, and a second TEM connectable to a rechargeable battery. The first TEM is configured as a Peltier device to receive power from the power source and provide a temperature gradient between two surfaces of the second TEM. The second TEM is configured as a Seebeck device to charge the rechargeable battery in response to the temperature gradient. A controller is configured to reverse polarity of the power source in response to passage of a predetermined period of time or in response to detection that the temperature gradient is below a predetermined threshold.

### FIELD OF THE INVENTION

The present invention relates to charging systems, devices and methods, such as battery charging using thermoelectric devices.

### BACKGROUND OF THE INVENTION

During the last several years, the use of portable devices that are powered by batteries have increased tremendously. Such devices include mobile phones, personal digital assistants (PDAs), remote controllers, scanners, electric toothbrushes and shavers, laptops etc. Often rechargeable batteries are used that, once drained, are recharged through a cable or cradle connected to AC power, such as a wall outlet, for example.

Typical chargers and chargeable devices includes contacts that are mated during recharging of the battery of the chargeable devices. Such charging systems with contacts suffer from a variety of disadvantages, including improper mating of the contacts due to improper positioning or contact failures, such as due to contact corrosion and dirt.

Contactless or non-contact charging systems have been developed such as using inductive chargers. Inductive chargers use transformers that have relatively large coils, particularly, to transfer the amount of power needed to charge a battery in a reasonable amount of time. These large coils require large housings and are not well suited for use in smaller devices. Further, batteries need to be typically charged over a narrow range of temperatures.

Accordingly, there is a need for improved charging systems and methods that provide contactless charging, and yet are well suited for large or small devices, and are operable or chargeable over a wide temperature range.

### SUMMARY OF THE INVENTION

One object of the present systems and methods is to overcome the disadvantages of conventional charging systems.

This and other objects are achieved by charging systems, devices and methods comprising a first thermoelectric module (TEM) connectable to a power source, and a second TEM connectable to a rechargeable battery. The first TEM is configured as a Peltier device to receive power from the power source and provide a temperature gradient between two surfaces of the second TEM. The second TEM is configured as a Seebeck device to charge the rechargeable battery in response to the temperature gradient. A controller is configured to reverse polarity of the power source in response to passage of a predetermined period of time or in response to detection that the temperature gradient is below a predetermined threshold.

The present charging systems, devices and method allow charging of batteries over wider temperature ranges than conventional chargers, are contactless yet amenable to charge, and/or be included in, small devices and shaped to fit housings of small devices.

Further areas of applicability of the present systems, devices and methods will become apparent from the detailed description provided hereinafter. It should be understood that the detailed description and specific examples, while indicating exemplary embodiments of the systems and methods, are intended for purposes of illustration only and are not intended to limit the scope of the invention.

### BRIEF DESCRIPTION OF THE DRAWINGS

These and other features, aspects, and advantages of the apparatus, systems and methods of the present invention will become better understood from the following description, appended claims, and accompanying drawing where:

FIG. 1 shows a thermoelectric (TE) device included in a charging system according to one illustrative embodiment of the present invention; and

FIG. 2 shows a charging system according to an illustrative embodiment of the present invention.

### DETAILED DESCRIPTION OF THE INVENTION

The following description of certain exemplary embodiments is merely exemplary in nature and is in no way intended to limit the invention, its application, or uses. In the following detailed description of embodiments of the present systems and methods, reference is made to the accompanying drawings which form a part hereof, and in which are shown, by way of illustration, specific embodiments in which the described systems and methods may be practiced. These embodiments are described in sufficient detail to enable those skilled in the art to practice the presently disclosed system and it is to be understood that other embodiments may be utilized and that structural and logical changes may be made without departing from the spirit and scope of the present system.

The following detailed description is therefore not to be taken in a limiting sense, and the scope of the present system is defined only by the appended claims. The leading digit(s) of the reference numbers in the figures herein typically correspond to the figure number, with the exception that identical components which appear in multiple figures are identified by the same reference numbers. Moreover, for the purpose of clarity, detailed descriptions of well-known devices and methods are omitted so as not to obscure the description of the present system.

The charging systems, devices and method uses thermoelectric (TE) technology which is based on the Peltier effect, a phenomenon first discovered in the early 19th century. The Peltier effect occurs whenever electrical current flows through two dissimilar conductors. Depending on the direction of current flow, the junction of the two conductors will either absorb or release heat. TE devices are usually constructed into pellets using Bismuth and Telluride. These pellets may be connected in various configurations to form stacked, cascaded, or multi-staged devices, and thus provide various desired voltage and current characteristics, as well as to have any desired shape and size.

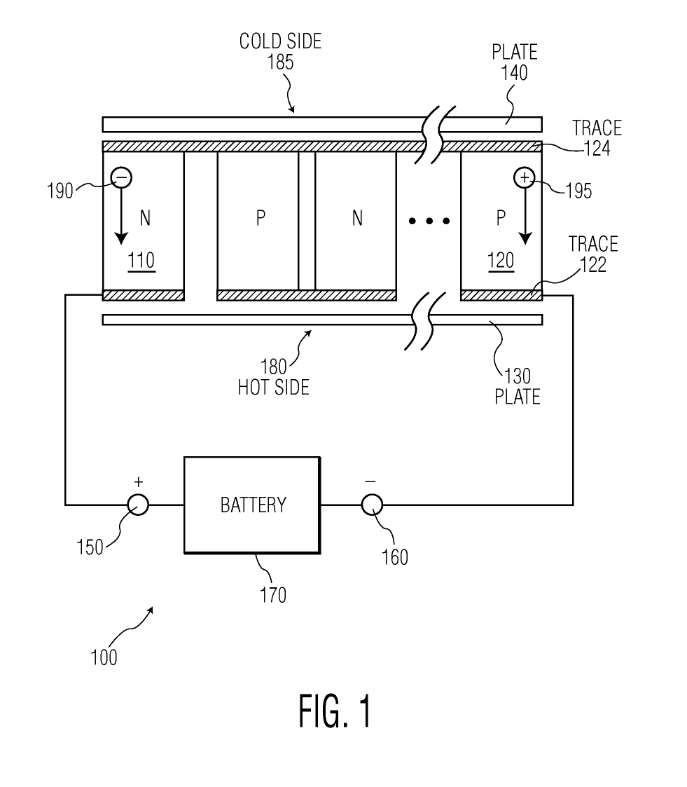

FIG. 1 shows a thermoelectric module (TEM) 100. The TEM is referred to as a Peltier device when a voltage is applied to free ends of the two dissimilar materials, such as P-type and N-type semiconductor 110, 120, to create a temperature difference between opposing surfaces. When a temperature differential or gradient is used for power generation, then the TEM 110 is referred to as a Seebeck device. The TEM 110 is a solid-state heat pump and maybe be any shape or size, including having a thickness of a few millimeters, for example.

As shown in FIG. 1, the TEM 100 includes at least one pair of N-type and P-type semiconductor 110, 120, e.g., P-doped and N-doped Bismuth Telluride (Bi₂Te₃). As shown by the dashed lines in FIG. 1, many P-doped and N-doped Bismuth Telluride cubes, pellets or elements 110, 120 may be interconnected via conductive material, e.g., copper traces 122, 124, to form an array of semiconductor elements. The copper traces 122, 124 may be patterned to electrically connect in series the bismuth Telluride P and N elements 110, 120, as well as to thermally connect in parallel the P and N elements 110, 120 to form the array.

The array of N-type and P-type elements 110, 120 may be sandwiched, e.g., soldered, between two ceramic plates 130, 140 which may be electric insulator and heat conductors. Further thermal layers or interface material, e.g., grease, pad or solder, may also be formed over the ceramic plates 130, 140. Typically, when used to cool objects for example, a heat sink may be attached to the hot side of the TEM 100.

As shown in FIG. 1, terminals 150, 160 may be connected to ends of the patterned copper trace 122 for connection to end N and P elements of the N—P array. It should be noted that the N and P doped Bismuth Telluride elements 110, 120 are not configured as diodes, i.e., there are no PN junctions. Further, a unit 170 is connected to the terminals 150, 160.

When the TEM 100 is operated as a Peltier device to transfer heat, then the unit 170 is a battery that provides a DC voltage. If a positive side of the battery 170 is connected to an N-doped pellet 110 and the negative side is connected to a P-doped pellet 130, then the lower side 180 of the TEM 100 becomes the hot side, while the upper side 185 is cooled. This is due to electron transport 190 in the N-doped pellet(s) 110 and hole transport 195 in the P-doped pellet(s) 120 from the cold side 185 (where heat is absorbed) to the hot side 180 (where heat is released).

When the TEM 100 is operated as a Seebeck device to generate power, then the unit 170 may be a rechargeable battery to be charged. Thus, if a temperature gradient is provided between the two opposing sides 180, 185, by either heating the hot side 180, or cooling the cold side 185, or both cooling and heating the appropriate sides, then current flows through the unit 170, which may be a load such as an electronic device for operation thereof, or a rechargeable batter for charging thereof.

As is well known, such TEM devices 100 are reversible. That is, by reversing the polarity of the supplied power at terminals 150, 160, the Peltier device reverses and what used to be the cold surface becomes the hot surface, and the previously hot surface becomes the cold surface. Further, by reversing the hot and cold surfaces, the polarity of the power generated by the Seebeck device is reversed.

The reversibility of the TEMs 100 is exploited by the present systems in two ways. First, the direction of heat pumping is switched by simply reversing the polarity of the applied voltage to a first TEM which is operated as a Peltier device. This in turn heat or cools one surface of a second TEM which is operated as a Seebeck device, thus generating power used for charging the battery 170, for example.

That is, heating of one surface is achieved with one voltage polarity, and cooling of the same surface is achieved with the reverse voltage polarity applied to the first TEM included in a charger. Second, a charging voltage of either polarity is produced by forcing a temperature delta or gradient across the second TEM included in the electronic unit to be charged.

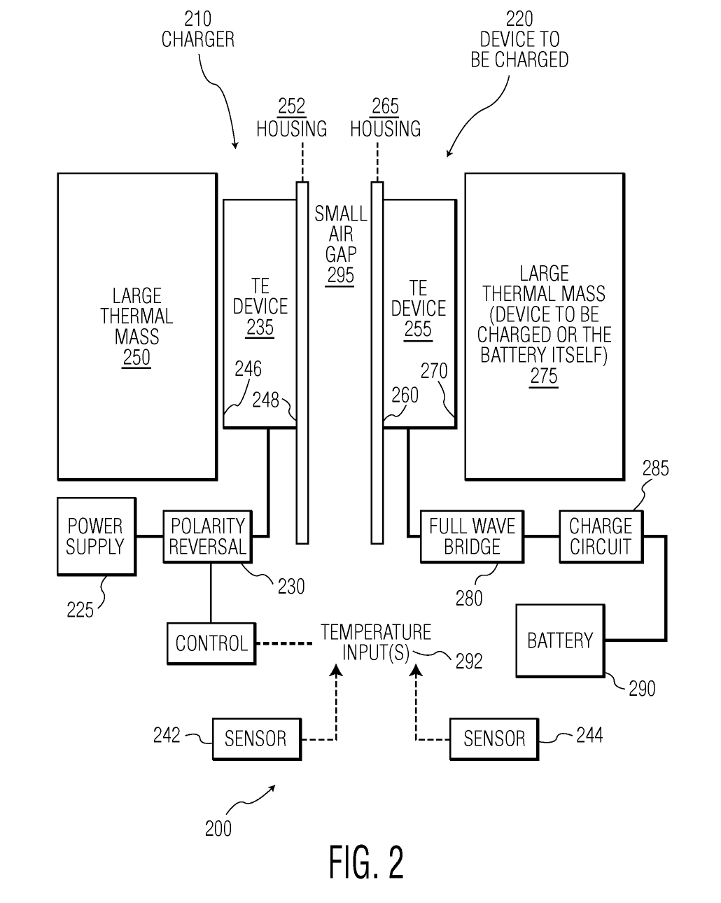

FIG. 2 shows a charging system 200 comprising a charger 210 and a unit to be charges 220, which may be any electronic device having a rechargeable battery, such as a mobile phone, PDA, remote controllers, scanner, electric toothbrushes and shavers, laptops etc. The charger 210 may be configured as a cradle to receive the unit to be charged, also referred to as the chargeable unit 220. The charger 210 includes a DC power supply 225 which may be plugged into an AC outlet to receive AC power and, as is well known, has AC/DC converter to convert the AC power to DC power.

The output of the DC power supply 225 is connected to a polarity reversal unit 230 which outputs a DC voltage of a desired polarity to a first thermoelectric module (TEM) or device 235. A controller 240 is configured to control the polarity reversal unit 230 to switch the polarity of the DC voltage when desired.

In one embodiment, the controller 240 controls the polarity reversal unit 230 to switch the polarity of the DC voltage after predetermined periods of time which may be preset by the manufacturer or manually set at any time, by the manufacturer, a third party, or the user for example. In another embodiment, the controller 240 controls the polarity reversal unit 230 to switch the polarity of the DC voltage in response to signals from an optional temperature sensing unit or detector 242 of the charger 210, and/or a further optional temperature sensing unit or detector 244 of the chargeable unite 220.

The charger detector 242 is configured to detect the temperature of one and/or both surfaces 246, 248 of the first TEM 235 which is configured or operable as a Peltier device. As shown in FIG. 2, one surface 246 is an inner surface adjacent to a large thermal mass, such as a heat sink 250, for example, and the other surface 248 is an outer surface adjacent the housing 252 of the charger 210.

For example, when a DC voltage of a particular polarity is applied to the N and P elements of the Peltier device or first TEM 235, the outer surface 248 will get hot and in inner surface 246 will get cold. As described in connection with FIG. 1, for example, the outer surface 248 will get hot when a positive voltage is applied to the N-element(s) and a negative voltage is applied to the P-element(s).

The hot temperature of the outer surface 248 may be detected by the sensor 242, and when this temperature reaches a certain predetermined temperature, then the controller 240 activates the reversal unit 230 to reverse the polarity of the DC voltage applied to the first TEM 235. Of course, as described, the controller 240 activates the reversal unit 230 to reverse the polarity after a predetermined time period, thus dispensing with the need for the temperature sensors 240, 244.

The newly applied DC voltage of reversed polarity causes the inner surface 246 to get hot and cools the outer surface 248, and when the inner surface 246 reaches the same or different predetermined temperature (or when the outer surface 248 reaches a predetermined cold temperature), then the DC voltage polarity is reversed again under the control of the controller 240 in response to temperature signals fed back to the controller by the sensor 242. Again, the sensors 242, 244 may be dispensed with and the controller 240 may be configured to cause polarity reversal at a predetermined frequency (or after the passage of predetermined time periods which may be the same or different for the different cycles), taking into account the size of the various elements of the charging system for example, such as reverse polarity every 5 minutes for example.

The chargeable unit 220 also includes another TEM. This second TEM 255 is configured or operable as a Seebeck device and has an outer surface 260 adjacent a housing 265 of the chargeable unit 220. An inner surface 270 of the second TEM or Seebeck device 255 is adjacent a large thermal mass 275, which is the rest or a large portion of the unit to be charged 220 and/or the rechargeable battery (to be charged) itself.

An AC/DC converter 280, such as a full wave bridge or rectifier is connected to the Seebeck device 255 to convert the AC power having a frequency of 1/(5 minutes), for example, to a DC voltage, which is provided to a charge circuit 285 that charges a rechargeable battery 290 connected thereto. As described, a further optional temperature sensor(s) 244 may also be provided in the chargeable unit 220 to detect the temperature of the various surfaces, such as the temperatures of the inner and outer TEM surfaces 260, 270, where these temperatures values are communicated to the controller 240 for activation of the polarity reversal unit 230 at the proper time, such as when the temperature gradient between the inner and outer surfaces 260, 270 of the Seebeck device 255 is low or not enough to generate a desired amount of power for charging the battery 290.

The controller 240 may be configured and calibrated to control the polarity reversal unit 230 to reverse the polarity of the applied DC voltage to the Peltier device 235 in response to the temperature of any element(s) or surface(s), or temperature gradient between the various element(s) or surface(s) of the charging system 200.

Illustratively, the controller 240 may be configured and calibrated to control the polarity reversal unit 230 to reverse the polarity of the applied DC voltage to the Peltier device 235 in response to the temperature gradient between the inner and outer TEM surfaces 260, 270 decreasing below a predetermined threshold. In addition or alternatively, the controller 240 may be configured and calibrated to control the polarity reversal unit 230 to reverse the voltage polarity in response to the temperature of the relatively large thermal mass 275 of the chargeable device 220 reaching predetermined thresholds, such as exceeding a first threshold or decreasing below a second threshold, as sensed by the chargeable unit sensor 244 (or by the charger sensor 242) and communicated as temperature information 292 to the controller 240, and compared by the controller 240 or a separate comparator to the predetermined thresholds stored in a memory, for example.

The temperature information 292 may be communicated to the controller 240 by any means, e.g., through mating data contacts of the charger 210 and the charging unit 220. Alternatively, or in addition, communication may be performed wirelessly through any means or protocols, such as Bluetooth, for example. As is well know to those skilled in the art of communication, various communication component may be included in both the charger 210 and the charging unit 220, such as antenna, transceivers, modulators/demodulators, coders/decoders, filters, etc.

In operation, chargeable unit 220 (or battery) is brought to close proximity of the charger 210 which may be a cradle. The chargeable unit 220 is positioned in the cradle 210 such that the two outer surfaces 248, 260 of the two TEMs 235, 255 are in close proximity, e.g., separated by a small air gap 295. The air gap should be as small as possible to minimize heat energy wasted or transferred to the ambient environment, and maximize heat energy transfer between the two outer surfaces 248, 260.

The outer surface 260 of the second TEM 255 is heated and cooled by the first TEM 235 which is operated as a Peltier device. The hot/cold outer surface 260 of the second TEM 255 is thus at a different temperature than the inner surface 270. This temperature gradient between the inner and outer surfaces 260, 270 of the second TEM 265, which is operated as a Seebeck device, causes power generation used for charging the rechargeable battery 290, as described in connection with FIG. 1.

The first cycle of operating the charging system 200, includes optionally sensing temperatures of the various elements and surfaces, such as the inner and outer surfaces 246, 248 of the first TE or Peltier device 235 by the sensor 242, and providing the temperature information 292 to the controller 240. In turn, the controller 240 uses the temperature information 292 to determine the direction of the first heating cycle. Initially, all the elements and surfaces may be at room temperature, for example, and thus any polarity may be used. Illustratively, the polarity is such that the outer surface 248 Peltier device 235 is heated by applying a positive voltage to the N-doped element(s) and a negative voltage to the P-doped element(s) of the Peltier device 235, for example.

Instead of relying on the temperature information 292, the temperature sensors 242, 244 may be eliminated and instead, the controller 240 controls the polarity reversal unit 230 based on predetermined time periods, such as to provide a voltage of a first polarity for a first predetermined time period during the initial cycle one, provide a voltage (e.g., of the same or different amplitude, and) of a second polarity (i.e., the reverse of the first polarity) during cycle two for a second predetermined time period, and back to the first polarity during cycle three for a third predetermined period, and so on. The various predetermined time periods may be the same or different, and may be predetermined by the manufacturer of the charger 210 and/or charging device 220, based on preliminary or calibration tests taking into account the various thermal masses and time periods for heating and cooling of the various surfaces of the TEM devices 235, 255 and thermal masses 250, 275, for example, so that desired temperatures of the various surfaces and elements are achieved without damage thereto.

In particular, the controller 240 controls the polarity reversal unit 230 to set the polarity of the DC voltage to cause heat to be transferred from the first TEM or Peltier device 235 to the second TEM or Seebeck device 255. For example, a positive DC voltage is applied to the N-doped pellets and a negative DC voltage is applied to the P-doped pellets of the Peltier device 235. This results in heating the outer surface 248 of the Peltier device 235 (and cooling of the inner surface 246), and heat transferred from the Peltier outer surface 248 to the outer surface 260 of the Seebeck device 255, through the air gap 295.

Thus, the outer surface 260 of the Seebeck device 255 becomes hotter than its inner surface 270, resulting in temperature delta or gradient across the inner and outer surfaces 260, 270 of the Seebeck device 255. The temperature gradient between the Seebeck inner and outer surfaces 260, 270 causes power to be transferred to the full wave bridge or AC/DC converter 280, as described in connection with FIG. 1, which is provided to the charging circuit 285 that charges the battery 290.

It should be noted that the temperature of the heat sink 250, which is next or adjacent to the Peltier cold inner surface 246, will drop only slightly over time because of the relatively large thermal mass of the heat sink 250, as compared to the mass of the Peltier device 235, for example. Similarly, as the heat from the outer surface 260 of the Seebeck device 255 is transferred to its inner surface 270 (which is next or adjacent to the large thermal mass 275 of the unit to be charged 220), the temperature of large thermal mass 275 will rise only slightly over time because of its relatively large thermal mass as compared to the Seebeck device 255, for example.

Knowing the various thermal masses and characteristics of the TEM devices 235, 255, and assuming a certain ambient or starting temperature range, such as 0° C. to 60° C. or 10° C. to 40° C. for example, the controller 240 controls the reversal unit 230 to provide a DC voltage of a first polarity from the power source 225 to the Peltier device 235, based on predetermined periods of time, or based on temperature information 292.

During cycle one, the temperature gradient across the Seebeck device 255, i.e., the temperature difference between its outer and inner surfaces 260, 270, will cause power generation which charges the battery 290.

After expiration of the first predetermined time period, (or in the case where at least one of the sensors 242, 244 is provided and the controller receives temperature information 292 of the hot Peltier outer surface 248, the cold Peltier inner surface 246 and/or the cold heat sink 250, and/or the reduced temperature gradient between the Seebeck inner surface 260 and outer surface 270, which is cooler than the inner surface 260, for example,) the controller 245 controls the polarity reversal unit 230 to switch or reverse the polarity of the DC voltage provided to the Peltier device 235, thus beginning cycle two. It should be noted that the heat sink 250 of the charger 210 will get cold as the inner surface 246 of the Peltier device 235 is cooled. Further, as heat is transferred from the Peltier hot outer surface 248 to the outer surface 260 of the Seebeck device 255, the Seebeck inner surface 270 will also get hot. The large thermal mass 275 of the unit to be charged 220 will also heat up but, due to its large mass, the large thermal mass 275 will not get as hot as the Seebeck inner surface 270.

The charging system 200 may be calibrated by the manufactures to determine the approximate amount of time needed for the various surfaces and elements to reach the various temperatures, and based on such calibration, predetermined time periods may be stored in a memory of the charging system 200 for comparison with elapsed time of voltage application, and reverse the voltage polarity when the elapsed time reaches the stored predetermined time periods, which may the same or different for the different cycles, for example.

Cycle 2 begins, for example, after the elapsed time of the first polarity voltage application reaches or exceed a stored predetermined threshold, or in response to at least one temperature signal 292 detected by at least one of the sensors 242, 244 reaches at least one of the stored thresholds, for example, indicating that the temperature gradient between the Seebeck inner and outer surfaces 260, 270 is not sufficient enough to generate a desired or predetermined amount of power for charging the battery 290.

During cycle 2, the controller 240 controls the polarity reversal unit 230 to switch or reverse the polarity of the DC voltage provided to the Peltier device 235, thus cooling the Peltier outer surface 248 (and heating the Peltier inner surface 246). The cold Peltier outer surface 248 cools the Seebeck outer surface 260, thus creating a temperature gradient between the Seebeck outer and inner surfaces 260, 270, which causes power generation and charging of the battery 290. Of course, the charge circuit 285 may be configured to change the polarity of the power or voltage generated by the Seebeck device 255 for proper charging of the battery 290.

Thus in cycle 2, heat is pulled from the Seebeck device 255, starting from its outer surface 260. Again, it should be noted that because of the large Seebeck thermal mass 275, which does not cool as quickly as the Seebeck outer surface 260, and thus also prevents the quick cooling of the Seebeck inner surface 270, a temperature delta or gradient is forced across Seebeck device 255, namely between the Seebeck outer and inner surfaces 260, 270, causing power to be transferred to the full wave bridge 280 which in turn charges the battery 290 through the charging circuit 285, for example.

It should be noted that the controller 240 may also be configured to interrupt the DC voltage provided to the Peltier device 235 when the temperature of the outer surface 245 exceeds or approaches a maximum temperature rating of Peltier device 235 to prevent damage thereto, for example.

Reversal of the voltage polarity applied to the Peltier device 235 continues through additional cycles, which are repeated pump or transfer heat to and from the Seebeck device 255 until the battery 290 is charged. Of course, a detector may be provided to detect that the battery 290 is charged, for example.

The methods of the present system are particularly suited to be carried out by a computer software program, such computer software program preferably containing modules corresponding to individual and/or composite steps or acts. Such software may of course be embodied in a computer-readable medium, such as an integrated chip, a peripheral device or memory, such as a memory of the charger 210 and/or the chargeable device 220 or other memory coupled to the controller or processor 240. A further controller or processor may also be provided in the chargeable device 220 for performing, or sharing with the performance of, some or all the tasks performed by the processor 240.

The controller or processor 240 may include micro-processors, central processing units (CPUs), digital signal processors (DSPs), ASICs, or any other processor(s) or controllers such as digital devices, or analog electrical circuits that perform the same functions, and employ electronic techniques and architecture. The processor 240 is typically under software control for example, and has or communicates with a memory that stores the software and other data such as user preferences.

The memory or memories of the charger 210 and/or the chargeable device 220 store data, such as time and/or temperature thresholds or other calibration or relevant data, as well as applications that configure the processor 240 to implement the methods, operational acts, and functions disclosed herein. The memories may be distributed or local and the processor 240, where additional processors may be provided, may also be distributed, or may be singular.

The memory or memories may be any computer readable and/or writeable medium, or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used.

The present charging systems, devices and method allow for contactless charging of batteries over wider temperature ranges than conventional chargers, such as beyond the typical temperature range of +5° C. to +45° C. necessary for conventional charging of batteries. Thus, batteries may be charged in harsh environment, such as extreme or cold temperature below +5° C. and above +45° C. since, for example, the controller 240 may be configured to operate the Peltier device 235 to set the temperature of the Seebeck thermal mass 275 and/or the battery 290 to any desired temperature.

Illustratively, if the battery 290 is part of the large thermal mass 275, then charging may occur at any ambient temperature because the controller 240 sets the temperature range of large thermal mass 275, consequently setting the temperature of the battery 290, during or prior to the initial the charge cycle. Further, the charging systems and devices may be any desired size and/or shape, as the two TEMs 255, 265 may be shaped and sized as desired to fit housings of small devices, for example.

Further, it is to be appreciated that any one of the above embodiments or processes may be combined with one or with one or more other embodiments or processes to provide even further improvements in charging systems and methods.

Finally, the above-discussion is intended to be merely illustrative of the present system and should not be construed as limiting the appended claims to any particular embodiment or group of embodiments. Thus, while the present system has been described in particular detail with reference to specific exemplary embodiments thereof, it should also be appreciated that numerous modifications and alternative embodiments may be devised by those having ordinary skill in the art without departing from the broader and intended spirit and scope of the present system as set forth in the claims that follow. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same or different items or structures or functions;

e) any of the disclosed devices or portions thereof may be combined together or separated into further portions unless specifically stated otherwise; and

f) no specific sequence of acts or steps is intended to be required unless specifically indicated.

The claimed invention is:

1. A charging system comprising:
a first thermoelectric module connectable to a power source; and
a second thermoelectric module connectable to a rechargeable battery;
wherein the first thermoelectric module is configured to receive power from the power source and provide a temperature gradient between two surfaces of the second thermoelectric module, and the second thermoelectric module is configured to charge the rechargeable battery in response to the temperature gradient.

2. The charging system of claim 1, further comprising a controller configured to reverse polarity of the power source in response to passage of a predetermined period of time.

3. The charging system of claim 2, wherein the power source includes a rectifier configured to convert AC power to DC power.

4. The charging system of claim 1, further comprising a sensor configured to sense the temperature gradient, and a controller configured to reverse polarity of the power source when the temperature gradient is below a predetermined threshold.

5. The charging system of claim 1, further comprising a rectifier configured to convert AC power generated by the second thermoelectric module to DC power for charging the rechargeable battery.

6. The charging system of claim 1, wherein the first thermoelectric module and the second thermoelectric module are separated by an air gap.

7. The charging system of claim 1, wherein the first thermoelectric module is included in a charger and the second thermoelectric module is included in a unit to be charged.

8. A charger comprising:
a first thermoelectric module; and
a second thermoelectric module;
wherein the first thermoelectric module is configured to receive power from a power source and transfer heat energy between a first surface of the first thermoelectric module and a second surface of the second thermoelectric module, and
wherein the second thermoelectric module is configured to charge a rechargeable battery in response to the transfer of the heat energy.

9. The charger of claim 8, wherein the transfer of the heat energy includes at least one of release of the heat energy to the second surface or absorption of the heat energy from the second surface.

10. The charger of claim 8, further comprising a controller configured to reverse polarity of the power source to alternatively heat and cool at least one of the first surface and the second surface over predetermined periods of time.

11. The charger of claim 8, wherein the power source includes a rectifier configured to convert AC power to DC power.

12. The charger of claim 8, further comprising a sensor configured to sense a temperature gradient between two surfaces of the second thermoelectric module, and a controller configured to reverse polarity of the power source when the temperature gradient is below a predetermined threshold.

13. The charger of claim 8, further comprising a rectifier configured to convert AC power generated by the second thermoelectric module to DC power for charging the rechargeable battery.

14. The charger of claim 8, wherein the first thermoelectric module and the second thermoelectric module are separated by an air gap.

15. The charger of claim 8, wherein the first thermoelectric module is included in a charging device and the second thermoelectric module is included in a unit to be charged.

16. A method of charging a rechargeable battery comprising the acts of:
applying a voltage having a first polarity to a first thermoelectric module to transfer heat energy between a first surface of a first thermoelectric module and a second surface of a second thermoelectric module and generate a temperature gradient between the second surface and a third surface of the second thermoelectric module; and
generating power in response to the temperature gradient to charge the rechargeable battery.

17. The method of claim 16, further comprising the act of reversing the first polarity to a second polarity in response to at least one of a predetermined time period and determination that the temperature gradient is below a predetermined threshold.

18. The method of claim 16, further comprising the acts of repeatedly reversing polarity of the voltage between the first polarity and a second polarity until the rechargeable battery is charged.

19. The method of claim 16, further comprising the act of rectifying the generated power.

20. The method of claim 16, further comprising the act of discontinuing the applying act when a temperature of at least one of the first surface and the second surface reaches at least one of a maximum temperature and a minimum temperature.
